(19) United States
(12) Patent Application Publication
(10) Pub. No.: US 2019/0057422 A1
(43) Pub. Date: Feb. 21, 2019

(54) PURCHASER-DRIVEN KEYWORD-BASED TRANSACTION SYSTEM FOR TRANSACTING PRODUCT AT LOW PRICE

(71) Applicant: Sung-gun PARK, Seoul (KR)

(72) Inventor: Sung-gun PARK, Seoul (KR)

(21) Appl. No.: 16/166,724

(22) Filed: Oct. 22, 2018

Related U.S. Application Data
(63) Continuation of application No. PCT/KR2018/005908, filed on May 24, 2018.

(30) Foreign Application Priority Data
May 24, 2017 (KR) 10-2017-0063895

(51) Int. Cl. G06Q 30/02; G06Q 30/06

(52) U.S. Cl. CPC G06Q 30/0283; G06Q 30/0282; G06Q 30/0625; G06Q 30/0256

(57) ABSTRACT

A purchaser-driven system for transacting a product at a low price is provided. The purchaser-driven system includes an operating server, a keyword transaction server, a purchaser terminal and a seller terminal. The purchaser selectively performs an immediate purchase or a joint purchase at a price lower than the showrooming price, and particularly the commission or the advertisement commission is adjusted through the purchaser evaluation and the target advertisement performed by grouping the remaining sellers filtered when the specific seller is selected, and correspondingly discounted amount is fed back to the purchaser, so that both the purchaser and seller receive benefits.

### CROSS-REFERENCE TO RELATED APPLICATION(S)

This application is a continuation application, claiming priority under § 365(c), of an International application number PCT/KR2018/005908, filed on May 24, 2018, which was based on and claimed benefit of a Korean patent application number 10-2017-0063895, filed on May 24, 2017, in the Korean Intellectual Property Office, the disclosure of which is incorporated by reference herein in its entirety

### BACKGROUND

### 1. Field

The disclosure relates to a purchaser-driven system for transacting a product at a low price. More particularly, the disclosure relates to a system configured to enable a product to be purchased immediately or jointly at a price lower than a showrooming price by matching a seller to a purchaser based on information inputted by the purchaser into a keyword transaction window, and configured to adjust a sales commission and an advertisement commission of the seller through one-person-one-rating system of the purchaser and a target advertisement performed by grouping remaining sellers filtered when selecting the specific seller, and adjust a discount amount corresponding to the commissions, thereby benefiting both the purchaser and the seller.

### 2. Description of Related Art

In general, a seller establishes a store for selling a specific product or service in a specific area, and a purchaser visits the store, pays related costs, and receives goods or services (hereinafter collectively referred to as a product) provided by the seller.

In addition, due to developed Internet and communication, a system recently has developed in which each purchaser or seller transacts a specific item through an Internet shopping mall after the shopping mall is established on the Internet.

Particularly, according to the above approach, it is unnecessary to establish a specific off-line store, and it is now possible to purchase the same item at a relatively low cost compared to purchasing the specific item through the off-line store while expanding sales networks over the country from a near region.

However, although a specific product may be purchased at a low cost according to the above approach, an appearance, a color, a texture or the like of the purchased product is actually different from the indirectly checked product because the specific product is indirectly checked and purchased just after reading photographs or articles posted on the Internet.

Therefore, a showrooming phenomenon recently occurs in which the purchaser visits an off-line store selling the specific item, researches the actual item, returns home, and then purchases the product at a low cost through the Internet shopping mall.

For the reference, since an Internet shopping mall company easily builds a shopping mall by simply building a website on the Internet without newly opening an off-line store, various companies have been established.

As a result, a price competition has intensified due to the flood of various internet shopping malls, and thus selling prices of the Internet shopping malls are slightly different from each other for the specific item.

Accordingly, a showrooming phenomenon occurs to purchase the specific item at low prices, in which each customer visits a specific store, confirms the corresponding item, returns home, and researches prices of the specific product on sale through Internet shopping malls, finds out a company selling the specific product at a relatively low price, and place an order.

However, although the showrooming phenomenon has activated transactions through Internet shopping malls, the price competition among Internet shopping mall companies has intensified. Especially, operating companies (such as Amazon and Alibaba) managing the shopping malls often impute damages caused by the price competition to vendors, or often shift burdens for an advertisement cost, a promotion cost, or a commission used for advertising the Internet shopping mall to the vendors.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system for allowing a specific product to be easily transacted at a price relatively lower than a showrooming price while preventing the above unreasonable problems, thereby enabling both purchaser and seller to receive benefits.

Another aspect of the disclosure is to provide a seller terminal for registering information on a specific product as a keyword and selling the product while confirming customer identification information.

Another aspect of the disclosure is to provide a purchaser terminal for searching for a price or a feature of the product on sale through the Internet, and requesting a purchase by inputting a price and a quantity of a corresponding product into a keyword transaction window through a keyword coding.

Another aspect of the disclosure is to provide a keyword transaction server for enabling the product to be transacted at a price lower than a showrooming price by matching the corresponding product of the seller based on the keyword and coded information for the specific product inputted into the purchaser terminal.

Additional aspects will be set forth in part in the description which follows and, in part, will be apparent from the description, or may be learned by practice of the presented embodiments.

In accordance with an aspect of the disclosure, a sales commission to be paid to the company operating the keyword transaction server is adjusted according to a result of customer evaluations after sales, and a discount amount the same as the adjusted sales commission is fed back to the purchaser, so that the specific product or service is transacted at a price lower than the showrooming price.

In accordance with another aspect of the disclosure, an account is opened after a network is established with a FinTech-based Internet bank (such as Kakao bank) server, such that the sales commission that the seller is required to pay, or the discount amount required to be fed back to the purchaser may be processed based on the account.

In accordance with another aspect of the disclosure, when a plurality of purchaser terminals coding-input similar keywords to request a standby purchase for a specific item, the keyword transaction server groups the purchaser terminals based on the inputted information and matches a selected specific seller to enable a request for a joint purchase, so that the purchaser may selectively purchase the specific item either immediately or jointly.

In accordance with another aspect of the disclosure, when the specific seller is selected for the joint purchase, remaining filtered sellers may be separately grouped to be targeted for advertisement.

In accordance with another aspect of the disclosure, when the specific item is purchased within a predetermined period of time through the target advertisement, the advertisement commission required to be paid to the operating company is adjusted according to a result of customer evaluations after sales, and the operating company feedbacks another discount amount correspondingly adjusted to the purchaser, so that the specific product or service is transacted at a lower price.

Therefore, the disclosure includes a keyword transaction server, a purchaser terminal and a seller terminal, and the specific product is transacted at a price lower than a showrooming price by matching the seller to the purchaser based on the inputted keyword or coded information by the purchaser, so that the purchaser can purchase the specific product at a lower price, the shopping mall operating company (such as Amazon and Alibaba) can receive increased commissions due to increased transactions, and the seller can minimize unnecessary commissions (such as advertising costs, promotion costs, and automatic loading fees for open-market products) to be paid to the shopping mall operating company, and thus all participants can take improved benefits.

In accordance with another aspect of the disclosure, when the seller is matched to the purchaser through the keyword transaction server, a target advertisement is promoted based on grouped information with respect to the keyword, so that the seller can actively perform marketing to purchasers while promoting the immediate purchase or joint purchase.

In accordance with another aspect of the disclosure, the customer evaluation is required for settlement of a customer discount and a sales payment after the specific product is delivered to the purchaser, so that healthy and trust-based business practices can be established.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 and 2 are block diagrams showing a system selectively proceeding between an immediate purchase or a joint purchase according to various embodiments of the disclosure;

FIG. 3 is a block diagram showing configurations of a keyword transaction server according to an embodiment of the disclosure;

FIG. 4A is a configuration diagram showing a screen of a purchaser terminal upon requesting an immediate purchase or a joint purchase according to an embodiment of the disclosure;

FIG. 4B is a flowchart showing a search process in a keyword transaction window according to an embodiment of the disclosure;

FIG. 5 is a configuration diagram showing a screen of a seller terminal according to an embodiment of the disclosure; and

FIG. 6 is a configuration diagram showing a target advertisement on a screen of a purchaser terminal according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The disclosure provides a system including: a seller terminal for registering information of a product as a keyword and selling the product; a purchaser terminal for searching for a price or a feature of the product on sale through the Internet, and requesting a purchase by coding-inputting a price and a quantity of a corresponding product into a keyword transaction window through a keyword coding; and a keyword transaction server for enabling the product to be transacted at a price lower than the showrooming price by matching the corresponding product of the seller based on the keyword and coded information for the specific product inputted into the purchaser terminal.

Hereinafter, embodiments for carrying out the disclosure will be described in detail with reference to the accompanying drawings.

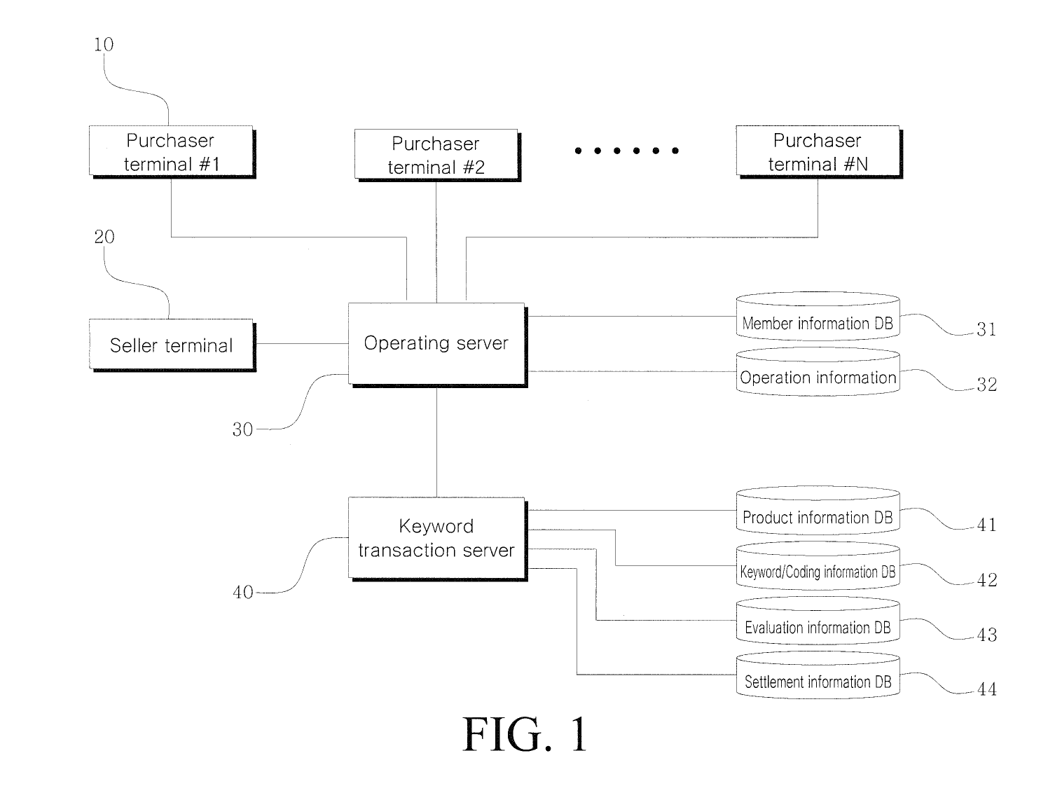

FIG. 1 is a diagram showing a system proceeding for an immediate purchase according to an embodiment of the disclosure.

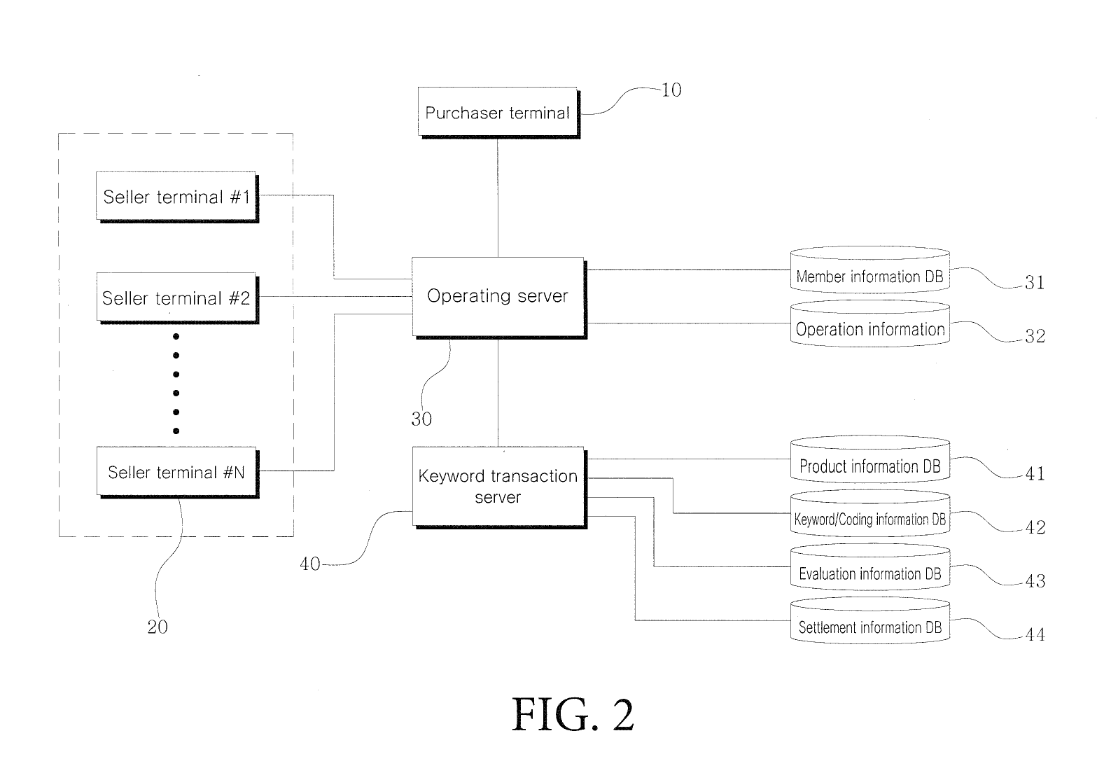

FIG. 2 is a diagram showing a system proceeding for a joint purchase according to an embodiment of the disclosure.

Referring to the above drawings, the disclosure relates to a system configured to enable a product to be immediately purchased or standby purchased (hereinafter referred to as “joint purchase”) at a price lower than a showrooming price by matching a seller to a purchaser based on the information inputted by the purchaser, and adjust a sales commission or an advertisement commission is adjusted according to an evaluation of the purchaser, thereby feeding back a discount amount corresponding to the adjustment to the purchaser, so that both the purchaser and the seller receive benefits.

The system includes: an operating server 30 configured to establish each personal identification information of the purchaser and the seller in a database, and operate a web page for transacting a specific product on the Internet; a seller terminal 10 configured to access the operating server 30 and register the specific product (herein, the specific product includes a specific commodity and a service product provided by the seller); a purchaser terminal 20 configured to access the operating server and coding-input a price and information (such as a quantity, and a model/name of the product) of the found specific product in the keyword transaction window; and a keyword transaction server 40 for searching for a registered product of the seller based on the information coding-inputted into the purchaser terminal and matching the product with the corresponding purchaser terminal so as to enable a transaction.

Hereinafter, each element will be described in more detail according to an embodiment of the disclosure.

First, the seller terminal 10 is a terminal provided by the seller, and serves to access the web page operated by the operating server and sell products to the purchaser.

The seller terminal accesses the operating server, establishes a shop for selling a specific product on the Internet, and registers information on the specific product/service as a keyword approach such that the registered product is matched to the purchaser. When a request for an immediate purchase or a standby purchase (hereinafter referred to as “joint purchase”) is received from each purchaser, the seller terminal may approve or reject each transaction.

The above seller terminal (hereinafter referred to as “seller”) may be a personal computer, a server, a notebook computer, a tablet PC, or a smart phone, or may be a POS terminal, a portable terminal, a mobile terminal, or a personal digital assistant (PDA) installed in a store according to an embodiment of the disclosure.

In addition, the purchaser terminal 20 is a terminal provided by the purchaser, and serves to access the operating server 30, register personal identification information of the purchaser upon membership registration, and search for a desired specific product by using a keyword or a coding-input into the keyword transaction window in a keyword type approach.

Herein, the purchaser terminal (hereinafter referred to as “purchaser”) may be a personal computer, a server, a notebook computer, a tablet personal computer (PC), or a smart phone, or may be a POS terminal, a portable terminal, a mobile terminal, or a PDA installed in a store according to an embodiment of the disclosure.

In addition, the operating server 30 is a server configured to connect the purchaser to the seller based on the Internet or mobile communication networks and operate a web page to transact the specific product,

Particularly, the operating server 30 includes a member information DB storing personal identification information of the accessed seller and purchaser, and an operational information DB for operating the web page.

Herein, the web page may be a site for an Internet shopping mall for transacting the specific product, may be a site including a search engine and capable of searching for information on the specific product, or may be a web page of a club or an apartment administration office in some embodiments.

In some embodiments, the operating server may establish a network with an Internet bank (such as Kakao bank) server.

Herein, the Internet bank server is a FinTech-based bank server that handles financial tasks through a smart phone or online, in which servers of Kakao bank and K-bank in Korea are typically included.

The Internet bank server creates an account for a seller or a purchaser based on the personal identification information registered upon joining the operation server, and creates an account for transferring a sales commission or an advertisement commission of the seller or a discount amount of the purchaser.

In addition, the keyword transaction server 40 is configured to induce a cyberrooming phenomenon in which the specific product is easily transacted at a cost lower than a price for purchasing the product through the showrooming.

Herein, the keyword transaction server 40 includes a product information DB 41 storing information on the product registered by the seller in a database, and a keyword/coding information DB 42 storing information on keyword and coding for the specific product or service registered by the seller.

Thus, when the purchaser coding-inputs the information of the product desired by the purchaser in the keyword approach, a corresponding specific product or service is found and matched to the purchaser, so that the purchaser transacts the specific product or service at a price lower than the showrooming price.

For the reference, the showrooming refers to a purchase of the same product through the Internet at a price lower than that of the product on sale in an off-line store after visiting the off-line store selling the specific product or service.

According to the cyberrooming, the purchaser checks a price in the off-line store, or a price or a condition of the product found through online or a smart phone search engine or search module, and inputs the price of the specific product together with relevant information in the keyword approach, so that the product is transacted at a price lower than the showrooming price when the seller approves the input.

For the reference, in some embodiments, the keyword transaction server 40 may further includes an evaluation information DB 43 storing evaluation results of purchasers in a database, and a settlement information DB 44 storing a sales commission adjusted in accordance with the evaluation result and a discounted amount or point fed back to correspond to the adjustment.

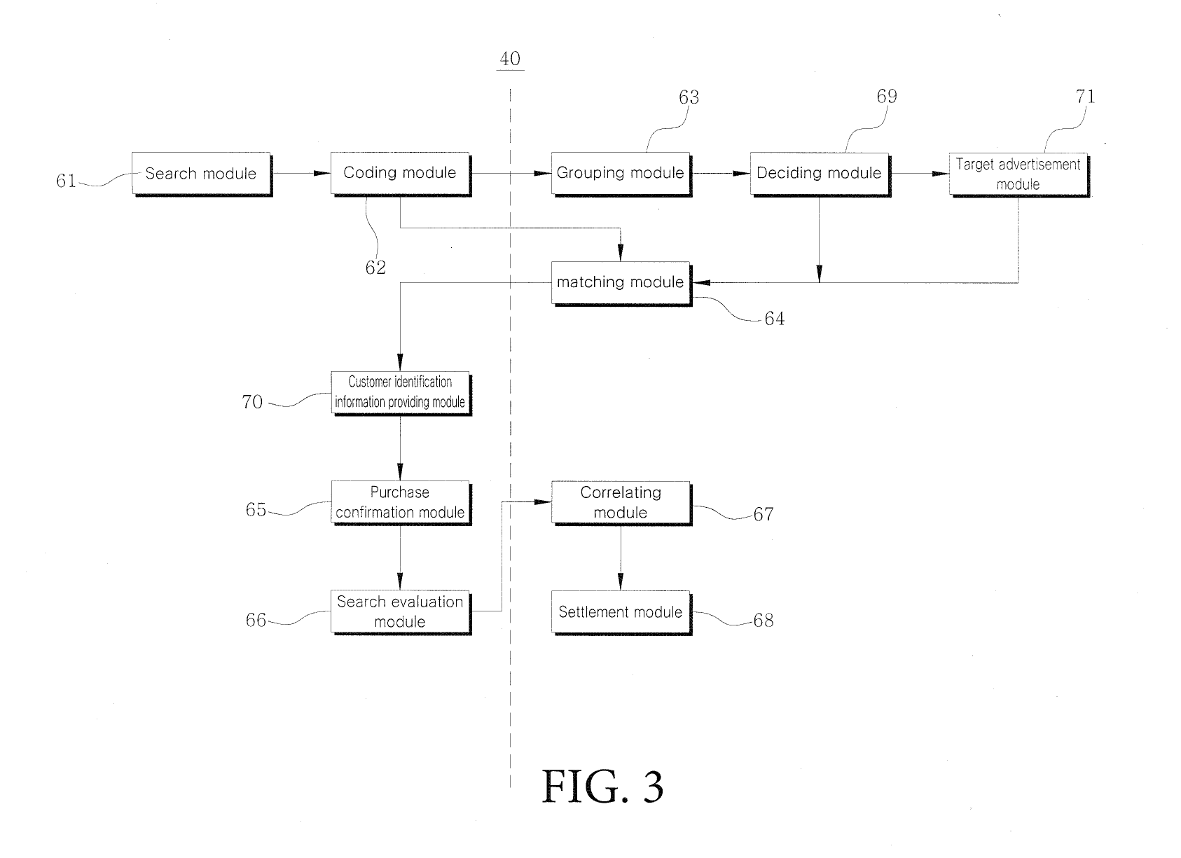

FIG. 3 is a block diagram showing configurations of the keyword transaction server according to an embodiment of the disclosure.

Herein, each module signifies a functional and structural combination of hardware and software for the technical idea of the disclosure.

Referring to the above drawings, the keyword transaction server 40 of the disclosure includes a search module 61, a coding module 62, a customer identification information providing module 70, a matching module 64 and a purchase confirmation module 65 to request an immediate purchase by the purchaser, or includes a grouping module 63 and a deciding module 69 to request a standby purchase (joint purchase).

In some embodiments of the disclosure, the keyword transaction server may include a purchase evaluating module 66, a correlating module 67, and a settlement module 68, such that the sales commission and the discount amount are adjusted according to the customer evaluation after the transaction.

In some embodiments, the keyword transaction server of the disclosure may further include a target advertising module 71 to adjust a target advertisement commission and another discount amount according to the customer evaluation after the transaction, through the grouping module 63, the deciding module 69, the purchase evaluating module 66, the correlating module 67, and the settlement module 68.

First, the search module 61 is configured to receive a feature, a price or the like of the specific product on sale through the Internet, so that product information of the specific product may be inputted and directly or indirectly searched through a search window, a tool bar, a banner or a keyword transaction window linked to a search engine of a specific portal company (such as Daum, Naver, and Google) or an Internet shopping mall (such as 11th Avenue, Auction, and Danawa).

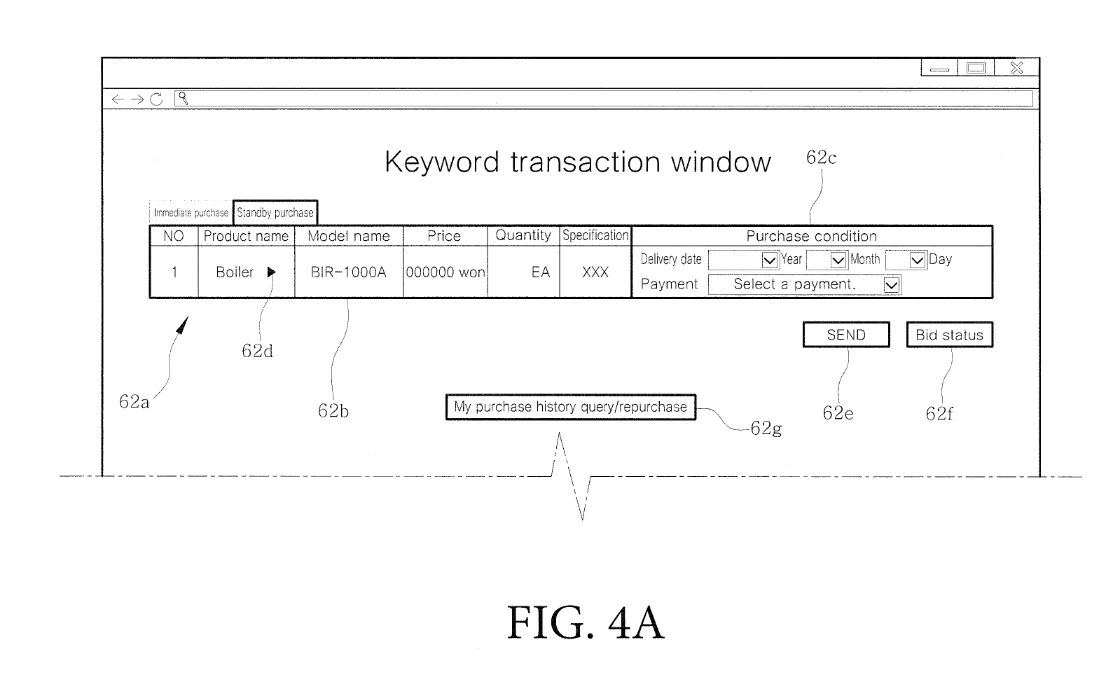

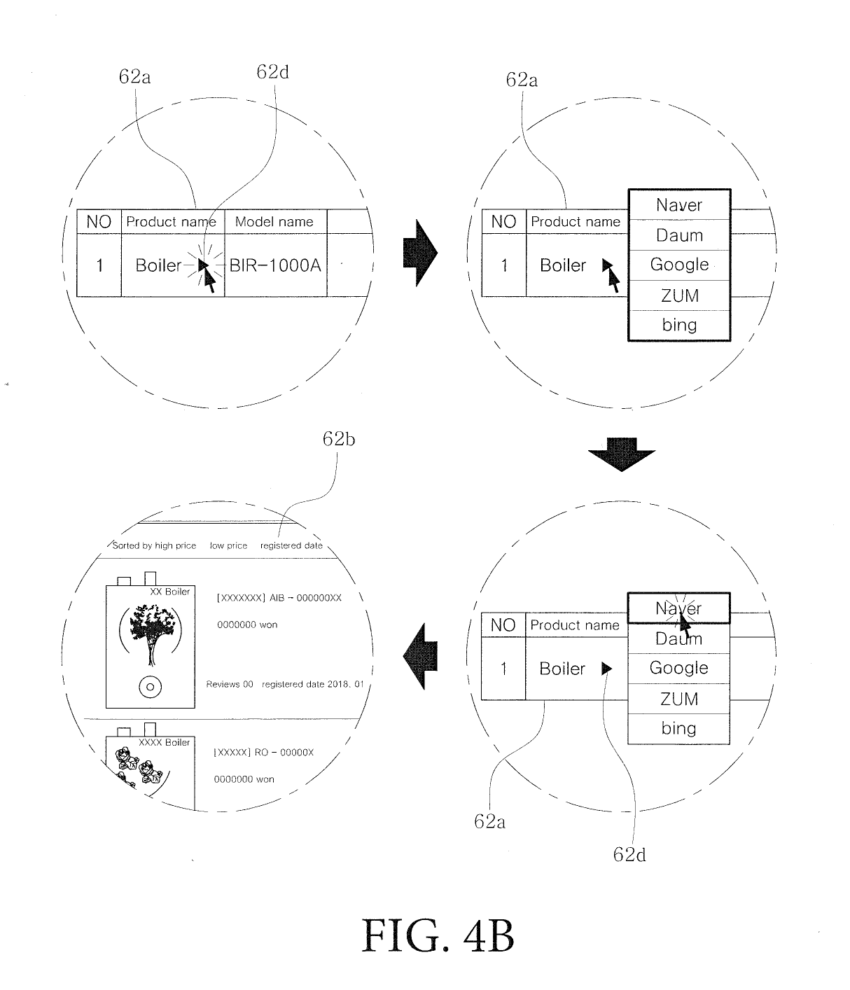

FIG. 4A is a configuration diagram showing a screen of a purchaser terminal upon requesting an immediate purchase or a joint purchase according to an embodiment of the disclosure.

Referring to FIG. 4A, the coding module 62 is a module for coding-inputting a keyword for a name, a price or the like of the corresponding product in the keyword transaction window based on the information of the specific product or service searched by the purchaser, and serves a keyword transaction window 62a defined therein with a plurality of boxes and columns to coding-input the keyword.

Herein, the keyword transaction window 62a basically includes a box 62b for coding-inputting the information of the product through a keyword, and a box 62c for registering a delivery condition, a payment condition, an after-sales condition or the like upon purchasing the product, includes a search button 62d for enabling the purchaser to easily search for the specific product through the keyword transaction window, a send button 62e for requesting matching a corresponding seller based on the inputted keyword, and a bidding status button 62f for checking matching results, and includes, in some embodiments, a My purchase history inquiry/repurchase button 62g for checking a purchase history of products purchased by the purchaser and enabling the purchaser to easily repurchase the corresponding product.

For the reference, the keyword basically includes text information inputted through a touch module or a keyboard, and may be implemented in various ways without limitation, such as a voice input via a microphone or a web crawling, in some embodiments.

Further, the keyword may be a trademark or a model name of a specific product, or may be a mixed keyword or contextual keyword that combines a name of a particular company with a name of the product, in some embodiments.

FIG. 4B is a flowchart showing a search process in a keyword transaction window according to an embodiment of the disclosure.

Referring to FIG. 4B, when the search button 62d is pressed, found results may be confirmed by searching for the product of the seller who registered the product information by using the keyword through the search module provided by the operating company, or a result window for checking the search results based on the keywords inputted into the keyword transaction window may open in conjunction with a portal company (such as Daum, Naver, and Google) or an Internet shopping mall (such as Danawa and Auction).

Further, a single product or large quantities of products are purchased through the keyword transaction window 62a, and purchase conditions such as an additional discount, a quantity promotion, a delivery cost or period, and an after-sales service may be coding-inputted.

In addition, the immediate purchase may be requested based on the information on the product or service and the purchase condition inputted into the keyword transaction window 62a, however, in some embodiments, the standby purchase (such as joint purchase) may be requested after waiting for a preset period of time while grouped by the keyword transaction server.

In addition, when purchasers request the standby purchase request through the coding module 62, the grouping module 63 is configured to group the purchasers who requested a purchase request for the same product for the preset time, thereby enabling a request for the joint purchase.

In addition, when the immediate purchase (hereinafter, referred to as “immediate purchase” or “individual purchase”) or the standby purchase (hereinafter referred to as “standby purchase” or “joint purchase”) is requested through the coding module, the matching module 64 selects at least one preferable seller through the keyword/coding information database based on the inputted keyword.

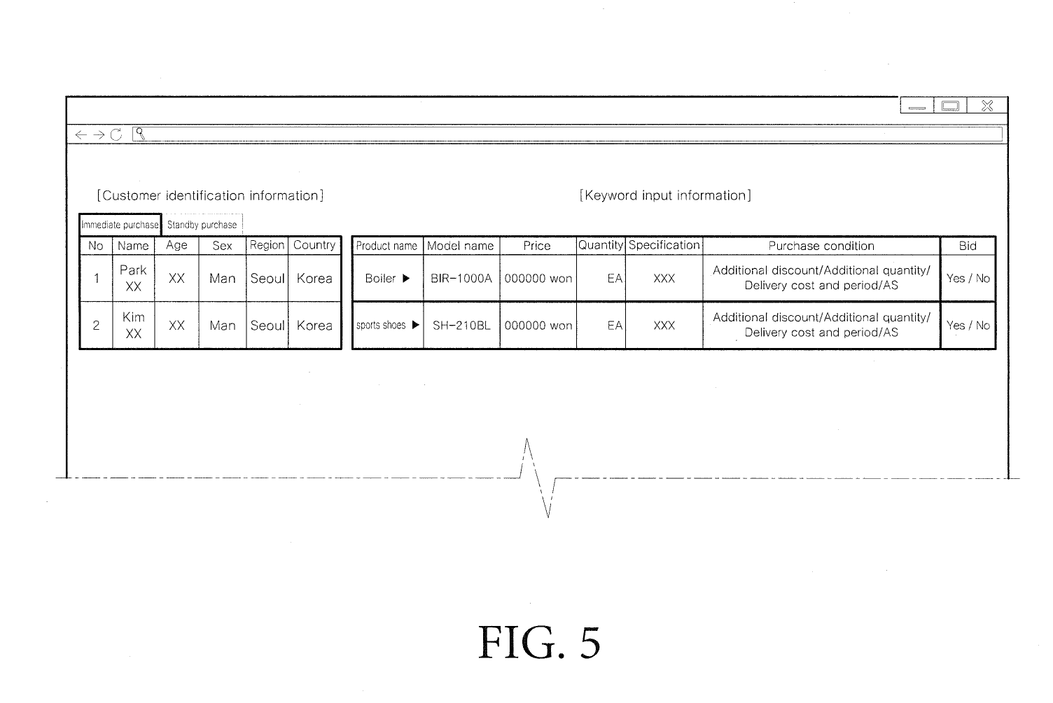

FIG. 5 is a configuration diagram showing a screen of a seller terminal according to an embodiment of the disclosure.

Referring to FIG. 5, the matching module 64 checks whether each purchaser accepts the transaction for the product at a predetermined price and indicates the result to the purchaser.

Herein, the matching module 64 allows the seller to check identification information of each purchaser loaded through the customer identification information providing module 70 together with the keyword information inputted by the purchaser to the seller.

The customer identification information providing module 70 is a module for loading the personal identification information of the purchaser and indicating the information to the seller, in which the personal identification information includes a name, a country, an address, a residence area, an age, a sex, or the like of the purchaser, and the identification information is used for actively performing a marketing by advertising the product or the like of the seller at an event day such as a birthday of the purchaser.

In addition, the deciding module 69 is configured to select a specific seller by filtering a plurality of sellers according to a preset rule and limiting the range.

For the reference, the deciding module 69 may be applied upon request of the individual purchase, or may be applied to prevent the request of the joint purchase from being canceled when the individual purchaser selects different seller in the case that a plurality of purchasers are informed to each purchaser upon request of the joint purchase.

According to the rule, the seller having the highest score, which is based on results obtained by counting ratings of the seller evaluated by the purchaser, is selected or the seller having the highest average rating is selected, such that transactions between a reliable seller and the purchaser are automatically performed.

According to the rule in some embodiments, after the sellers are selected within a specified range such as a small-sized, medium-sized or large-sized group with at least a predetermined amount of evaluation score according to the amount or quantity of transactions, such that sellers may be automatically informed to the purchaser. However, the disclosure is not limited to the embodiments and may be variously modified and carried out.

In addition, the target advertising module 71 is a module for grouping and target-advertising remaining sellers filtered when the specific sellers are selected by the grouping module 63 and the deciding module 69.

In some embodiments, the operating company may perform a target-advertisement by grouping specific products on the basis of a purchase history or search results of a member (such as a purchaser) through the target advertising module 71.

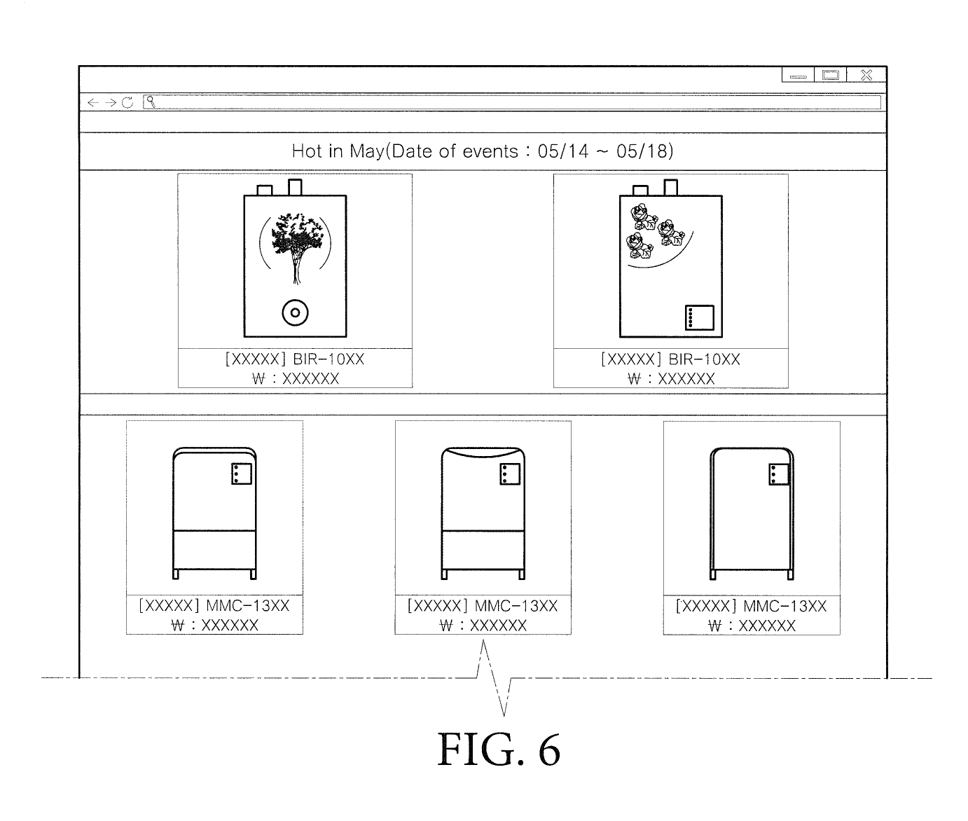

FIG. 6 is a configuration diagram showing a target advertisement on a screen of a purchaser terminal according to an embodiment of the disclosure.

Referring to FIG. 6, information on products grouped during the preset period of time is provided to each purchaser through the target advertising module 71.

Herein, according to the disclosure, when the purchaser purchases the specific product being advertised through the target advertising module 71, a part of a target advertisement commission paid by the seller to the operating company is fed back to the purchaser, so that the effectiveness of the target advertisement is increased and the specific product is purchased at a lower price.

In addition, the purchase confirmation module 65 is a module for requesting the purchaser to pay costs related to the corresponding product or service when the purchaser is matched with the seller through the keyword transaction server.

In addition, the purchase evaluating module 66 is a module for requesting the purchaser to evaluate the product through the keyword transaction server when the product or service is provided, in which the module requests the purchaser to evaluate the product and select one among High, Intermediate and Low.

Herein, the evaluation may be variously modified and carried out according to embodiments.

Particularly, when the evaluation is not performed by the purchaser for a predetermined period of time, a designated evaluation (such as Intermediate) may be automatically selected.

In addition, the correlating module 67 is a module configured to adjust the sales commission and the advertisement commission according to the result evaluated through the purchase evaluating module, and accordingly decide the discount amount or point to be fed back to the purchaser.

For example, when the sales commission paid by the seller to the operating company is increased according to the evaluation result, the correlating module 67 decreases a discount amount or point fed back to the purchaser according to the increase of sales commission.

More specifically, when the evaluation result of the purchaser is ranked High, the sales commission paid by the seller to the operating company is decided as N %, and the discount amount fed back by the operating company to the purchaser is automatically decided as M %.

In addition, when the evaluation result of the purchaser is ranked intermediate, the sales commission paid by the seller to the operating company is increased as N+1%, and correspondingly, the discount amount or point fed back by the operating company to the purchaser is automatically decreased as M−1%.

Further, when the evaluation result of the purchaser is ranked low, the sales commission paid by the seller to the operating company is increased as N+2%, and correspondingly, the discount amount or point fed back by the operating company to the purchaser is decreased as M−2%.

Herein, the sales commission or discount amount decided by the correlating module may be variously modified according to embodiments.

In some embodiments, when one of products advertised through the target advertising module 71 for a predetermined period is purchased, the correlating module 67 may increase or decrease the advertisement commission paid by the seller to the operating company according to the evaluation result obtained through the purchase evaluating module 66, and correspondingly, may decrease or increase another discount amount fed back to the purchaser.

In other words, when the evaluation result of the purchaser is ranked High, the correlating module decides the sales commission paid by the seller to the operating company as N %, and correspondingly, automatically decides the another discount amount fed back by the operating company to the purchaser as B %.

When the evaluation result of the purchaser is ranked intermediate, the target advertisement commission paid by the seller to the operating company is increased as A+1%, and correspondingly, the another discount amount fed back by the operating company to the purchaser is decreased as B−1%.

When the evaluation result of the purchaser is ranked low, the target advertisement commission paid by the seller to the operating company is increased as A+2%, and correspondingly, the another discount amount fed back by the operating company to the purchaser is decreased as B−2%.

Herein, the target advertisement commission or the another discount amount decided by the correlating module may be variously modified according to embodiments.

In addition, the settlement module 68 instructs the seller to transfer the sales commission calculated by the correlating module and instructs a transfer of the discount amount by applying to the price paid when placing an order for the product.

Herein, in some embodiments, the settlement module may also instruct the seller to transfer the advertisement commission to be paid after executing the target advertisement and instruct a transfer of the another discount amount to the purchaser.

Therefore, the disclosure relates to a system in which the purchaser may selectively perform the immediate purchase or joint purchase at a price lower than the showrooming price, and particularly, the commission or the advertisement commission is adjusted through the purchaser evaluation and the target advertisement performed by grouping the remaining sellers filtered when the specific seller is selected, and the correspondingly discounted amount is fed back to the purchaser, so that both the purchaser and the seller receive benefits.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A keyword-based transaction system comprising:
a seller terminal for registering information of a specific product as a keyword for selling the specific product;
a purchaser terminal for searching for a price or a feature of the specific product on sale through Internet, and requesting a purchase by inputting a price and a quantity of the specific product in a keyword transaction window through a keyword coding; and
a keyword transaction server for transacting a product of the seller at a price lower than a showrooming price by matching the product of the seller based on the keyword and coded information for the specific product inputted into the purchaser terminal.

2. The keyword-based transaction system of claim 1, wherein the keyword transaction server comprises:
a search module for searching for a price or information of the specific product on sale through the Internet;
a coding module for coding-inputting a keyword for the specific product into the keyword transaction window based on the information confirmed through the search module; and
a matching module for loading information of a corresponding product of the seller and matching the product information to a purchaser based on the information inputted into the coding module, thereby enabling a request for an immediate purchase; or
wherein the keyword transaction server comprises:
a grouping module for grouping purchasers who apply a purchase of a same product for a predetermined period of time to request a joint purchase when a standby purchase is requested for the predetermined period of time, based on the information inputted into the coding module, and
a deciding module configured to select a specific seller by filtering a plurality of sellers according to a preset rule and match the specific seller to the grouped purchasers, thereby enabling a request of the joint purchase,
so that the immediate purchase or the joint purchase for the specific product is selectively performed by the purchaser.

3. The keyword-based transaction system of claim 2, wherein the keyword transaction server further comprises a target advertising module for grouping filtered sellers to target-advertise the filtered sellers when the grouping module and the deciding module for the joint purchase select the specific seller.

4. The keyword-based transaction system of claim 2, wherein the keyword transaction server further comprises:
a purchase evaluating module for requesting the purchaser to select and evaluate one of a plurality of ratings for the product;
a correlating module for adjusting a discount amount fed back to the purchaser such that the discount amount is decreased or increased, corresponding to a sales commission which is paid by the seller is increased or decreased according to an evaluation result obtained through the purchase evaluating module; and
a settlement module for instructing the seller to transfer the sales commission calculated through the correlating module and for instructing the transfer of the fed back discount amount to the purchaser.

5. The keyword-based transaction system of claim 4, wherein, when one of the products advertised through the target advertising module is purchased within a preset period of time, the correlating module decides an advertisement commission to be paid by the seller to an operating company by increasing or decreasing the advertisement commission based on the evaluation result obtained through the purchase evaluating module, and decreases or increases another discount amount, which is fed back by the operating company to the purchaser, corresponding to the increase or decrease of the advertisement commission, and the settlement module calculates the advertisement commission of the seller and the another discount amount of the purchaser.

6. The keyword-based transaction system of claim 4, wherein the correlating module,
when the evaluation result of the purchaser is ranked high, determines the sales commission paid to the operating company as N %, and automatically determines the discount amount fed back to the purchaser as M % corresponding to the sales commission;
when the evaluation result of the purchaser is ranked intermediate, increases the sales commission paid by the seller to the operating company as N+1%, and decreases the discount amount fed back by the operating company to the purchaser as M−1%; and
when the evaluation result of the purchaser is ranked low, increases the sales commission paid by the seller to the operating company as N+2%, and decreases the discount amount fed back by the operating company to the purchaser as M−2%.

7. The keyword-based transaction system of claim 5, wherein the correlating module,
when the evaluation result of the purchaser is ranked high, determines the target advertisement commission paid by the seller to the operating company as A %, and automatically determines the another discount amount fed back by the operating company to the purchaser as B %;
when the evaluation result of the purchaser is ranked intermediate, increases the target advertisement commission paid by the seller to the operating company as A+1%, and decreases the another discount amount fed back by the operating company to the purchaser as B−1%;
when the evaluation result of the purchaser is ranked low, increases the target advertisement commission paid by the seller to the operating company as A+2%, and decreases the another discount amount fed back by the operating company to the purchaser as B−2%.

8. The keyword-based transaction system of claim 1, wherein an operating server or the keyword transaction server comprises a FinTech-based internet bank server for creating an account to cope with a sales commission, an advertisement commission, a discount amount, or another discount amount, based on personal identification information registered upon membership registration.

9. The keyword-based transaction system of claim 2, wherein the matching module guides keyword information inputted by the purchaser into the keyword transaction window, and personal identification information of the corresponding purchaser loaded through a customer identification information providing module to the seller.
